(19) United States
(12) Patent Application Publication
(10) Pub. No.: US 2012/0235472 A1
(43) Pub. Date: Sep. 20, 2012

(54) POWER SOURCE CONTROL DEVICE AND METHOD, AND POWER MANAGEMENT SYSTEM

(75) Inventors: Takashi Aragai, Kasugai-shi (JP); Yusuke Ukai, Komaki-shi (JP); Hirohito Miyazaki, Gifu-shi (JP)

(73) Assignee: OMRON AUTOMOTIVE ELECTRONICS CO., LTD., Komaki (JP)

(21) Appl. No.: 13/421,287

(22) Filed: Mar. 15, 2012

(30) Foreign Application Priority Data
Mar. 15, 2011 (JP) 2011-056160

(51) Int. Cl. B60L 1/00

(52) U.S. Cl. 307/9.1

(57) ABSTRACT

Power to a load may be continued even if abnormality occurs in a load current value supplied to the relevant load of a vehicle. Load control units supply power from a battery to corresponding loads, respectively, and detect load current values. A power source management unit detects a total current value, based on the load current values detected by the load control units. Where the load control unit in which the load current value exceeds a load current threshold is present, when the total current value exceeds a total current threshold, the power source management unit causes the supply of the power from the relevant load control unit to the load to be stopped. When the total current value is equal to or lower than the total current threshold, the power source management unit continues the supply of the power from the relevant load control unit to the load.

### BACKGROUND OF THE INVENTION

1. Technical Field

The present invention relates to a power source control device and a method of the same, and a power management system, and particularly to a power source control device for vehicle and a method of the same, and a power management system.

2. Related Art

Conventionally, in order to realize electric power saving, downsizing and the like, there have been proposed various methods for supplying power to respective loads (electric components) mounted on a vehicle.

For example, a technique has been proposed in which a dedicated control unit, a dedicated switch, and a dedicated power supply circuit are provided for each of the loads, and control is performed so that when an IG (ignition) switch is off, only the load to which power-on is requested by the switch is supplied with power (e.g., refer to Japanese Unexamined Patent Publication No. 2009-83527).

Moreover, for example, a technique has been proposed in which when a power feed control device provided in a vehicle accepts a request to feed power from an individual power feed switch, whether or not the power feed is permitted is determined, based on a state of a power source and an electric quantity supplied to the load, and when it is determined that the power feed is permitted, the power is fed to the load for which the request is made (e.g., refer to Japanese Unexamined Patent Publication No. 2008-61461).

Furthermore, for example, a technique has been proposed in which switching devices are provided between a plurality of systems mounted on a vehicle and a power source, respectively, and one monitoring device is provided that collectively monitors states of respective control devices by communicating with the control devices of the respective systems, and switches on/off the respective switching devices to thereby control electric connection between the respective systems and the power source (e.g., refer to Japanese Unexamined Patent Publication No. 2008-220058).

### SUMMARY

One or more embodiments of the present invention enable power supply to a load to be continued as much as possible even if abnormality occurs in a load current value supplied to the relevant load of a vehicle.

According to a first aspect of one or more embodiments of the present invention, there is provided a power source control device provided in a vehicle including a plurality of power supply devices that supply power from a power source to respective corresponding loads, the power source control device including a total current detecting unit that detects a total current value, which is a summation of load current values, based on the load current values that are supplied from the power supply devices to the loads and are detected in the respective power supply devices, and a power supply control unit that causes the supply of the power from the relevant power supply device to the load to be stopped when the total current value exceeds a predetermined total current threshold, and causes the supply of the power from the relevant power supply device to the load to be continued when the total current value is equal to or lower than the total current threshold, in the case where the power supply device in which the load current value exceeds a predetermined load current threshold is present.

In the power source control device of the first aspect of one or more embodiments of the present invention, the total current value, which is the summation of the load current values, is detected, based on the load current values that are supplied from the power supply devices to the loads and are detected in the respective power supply devices, and in the case where the power supply device in which the load current value exceeds the predetermined current threshold is present, when the total current value exceeds the predetermined total current threshold, the supply of the power from the relevant power supply device to the load is stopped, and when the total current value is equal to or lower than the total current threshold, the supply of the power from the relevant power supply device to the load is continued.

Accordingly, even if abnormality occurs in the load current value supplied to the load, the power supply to the relevant load can be continued as much as possible.

This power source is made of, for example, a battery. This vehicle is made of, for example, an engine vehicle, an EV (Electric Vehicle), an HEV (Hybrid Electric Vehicle), a PHEV (Plug-in Hybrid Electric Vehicle) or the like. The above-described total current detecting unit and power supply control unit are each an arithmetic operation device such as, for example, a CPU (Central Processing Unit), an MPU (Micro Processing Unit), an ECU (Electronic Control Unit), and the like. Either of the following two determinations may precede. (1) Determination of whether or not the load current value exceeds the predetermined load current threshold. (2) Determination of whether or not the total current value exceeds the predetermined total current threshold.

This power supply control unit can cause the supply of the power from the relevant power supply device to the load to be continued when the load of the power supply device in which the load current value exceeds the load current threshold is a load involving predetermined driving safety of the vehicle.

Accordingly, the driving safety of the vehicle can be secured, even if the abnormality occurs in the load current value.

The loads involving the driving safety of the vehicle include a traveling system load such as, for example, an Electric Power Steering (EPS), an electric brake, an Engine Control Unit (ECU), and the like, and loads that will interfere with driving or decrease the safety unless they operate, such as a headlight, a wiper, an SRS (Supplemental Restraint System) air-bag system, and the like.

In the case where the vehicle is in a predetermined state where the vehicle is at least not traveling, this power supply control unit can cause the supply of the power from the relevant power supply device to the load to be stopped even when the load of the power supply device in which the load current value exceeds the load current threshold is the load involving the driving safety of the vehicle.

Thereby, when the abnormality occurs in the load current value and the total current value, the loads involving the driving safety of the vehicle can be stopped similarly to the other loads in accordance with the presence or absence of necessity to secure the driving safety of the vehicle.

When abnormality of the load current value is notified from the power supply device, the power supply control unit can cause the determination of whether or not the total current value exceeds the total current threshold to be performed, and when the total current value exceeds the total current threshold, the power supply control unit can cause the supply of the power from the relevant power supply device to the load to be stopped, while when the total current value is equal to or lower than the total current threshold, the power supply control unit can cause the supply of the power from the relevant power supply device to the load to be continued.

Accordingly, the number of times of operations of the power source control device can be decreased, so that the burden on the processing of the power source control device can be reduced.

This load current threshold can be set individually for each of the loads.

Accordingly, each of the loads can be stopped on more proper conditions.

According to the first aspect of one or more embodiments of the present invention, there is provided a power source control method in a vehicle including a plurality of power supply devices that supply power from a power source to respective corresponding loads, including the steps of detecting a total current value, which is a summation of load current values, based on the load current values that are supplied from the power supply devices to the loads and are detected in the respective power supply devices, and causing the supply of the power from the relevant power supply device to the load to be stopped when the total current value exceeds a predetermined total current threshold, and causing the supply of the power from the relevant power supply device to the load to be continued when the total current value is equal to or lower than the total current threshold, in the case where the power supply device in which the load current value exceeds a predetermined load current threshold is present.

In the power source control method of the first aspect of one or more embodiments of the present invention, the total current value, which is the summation of the load current values, is detected, based on the load current values that are supplied from the power supply devices to the loads and are detected in the respective power supply devices, and in the case where the power supply device in which the load current value exceeds the predetermined current threshold is present, when the total current value exceeds the predetermined total current threshold, the supply of the power from the relevant power supply device to the load is stopped, and when the total current value is the total current value is equal to or lower than the total current threshold, the supply of the power from the relevant power supply device to the load is continued.

Accordingly, even if abnormality occurs in the load current value supplied to the load, the power supply to the relevant load can be continued as much as possible.

This power source is made of, for example, a battery. This vehicle is made of, for example, an engine vehicle, an EV, an HEV, a PHEV or the like. The processing of each of the steps is executed by an arithmetic operation device such as, for example, a CPU, an MPU, an ECU, and the like.

According to a second aspect of the present invention, there is provided a power management system for a vehicle, including a plurality of power supply devices and a power source control device, wherein each of the plurality of power supply devices includes a power supply unit that supplies power from a power source to a corresponding load, and a load current detecting unit that detects a load current value supplied to the load, and the power source control device includes a total current detecting unit that detects a total current value, which is a summation of the load current values, based on the load current values that are detected in the power supply devices, and a power supply control unit that causes the supply of the power from the relevant power supply device to the load to be stopped when the total current value exceeds a predetermined total current threshold, and causes the supply of the power from the relevant power supply device to the load to be continued when the total current value is equal to or lower than the total current threshold, in the case where the power supply device in which the load current value exceeds a predetermined load current threshold is present.

In the power management system of the second aspect of one or more embodiments of the present invention, by each of the plurality of power supply devices, the power from the power source is supplied to the corresponding load, and the load current value supplied to the load is detected, and by the power source control device, the total current value, which is the summation of the load current values, is detected, based on the load current values detected in the respective power supply devices, and in the case where the power supply device in which the load current value exceeds the predetermined load current threshold is present, the supply of the power from the relevant power supply device to the load is stopped when the total current value exceeds the predetermined total current threshold, while the supply of the power from the relevant power supply device to the load is continued when the total current value is equal to or lower than the total current threshold.

Accordingly, even if abnormality occurs in the load current value supplied to the load, the power supply to the relevant load can be continued as much as possible.

This power source is made of, for example, a battery. This vehicle is made of, for example, an engine vehicle, an EV, an HEV, a PHEV, or the like. This power supply unit is made of an arithmetic operation device such as, for example, a CPU, an MPU, an ECU, and the like, various electric circuits, and the like. This load current detecting unit is made up of, for example, a current sensor or a current transformer. Each of the above-described total current detecting unit and power supply control unit is made of an arithmetic operation device such as, for example, a CPU, an MPU, an ECU, and the like.

According to the first aspect and the second aspect of one or more embodiments of the present invention, the power supply to the load can be continued as much as possible even if abnormality occurs in the load current value supplied to the relevant load of the vehicle.

### BRIEF DESCRIPTION OF THE DRAWINGS

FIG. 1 is a block diagram showing one or more embodiments of a power management system;

FIG. 2 is a block diagram showing a configuration example of a verification system;

FIG. 3 is a block diagram showing a configuration example of a power source management unit;

FIG. 4 is a block diagram showing a configuration example of a load control unit;

FIG. 5 is a flowchart for describing processing of the load control unit;

FIG. 6 is a flowchart for describing the processing of the load control unit;

FIG. 7 is a flowchart for describing processing of the power source management unit;

FIG. 8 is a flowchart for describing the processing of the power source management unit;

FIG. 9 is a flowchart for describing processing of a verification unit.

### DETAILED DESCRIPTION

Hereinafter, an embodiment of the present invention (hereinafter, referred to as an embodiment) will be described with reference to the drawings. In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

[Configuration Example of Power Management System 11]

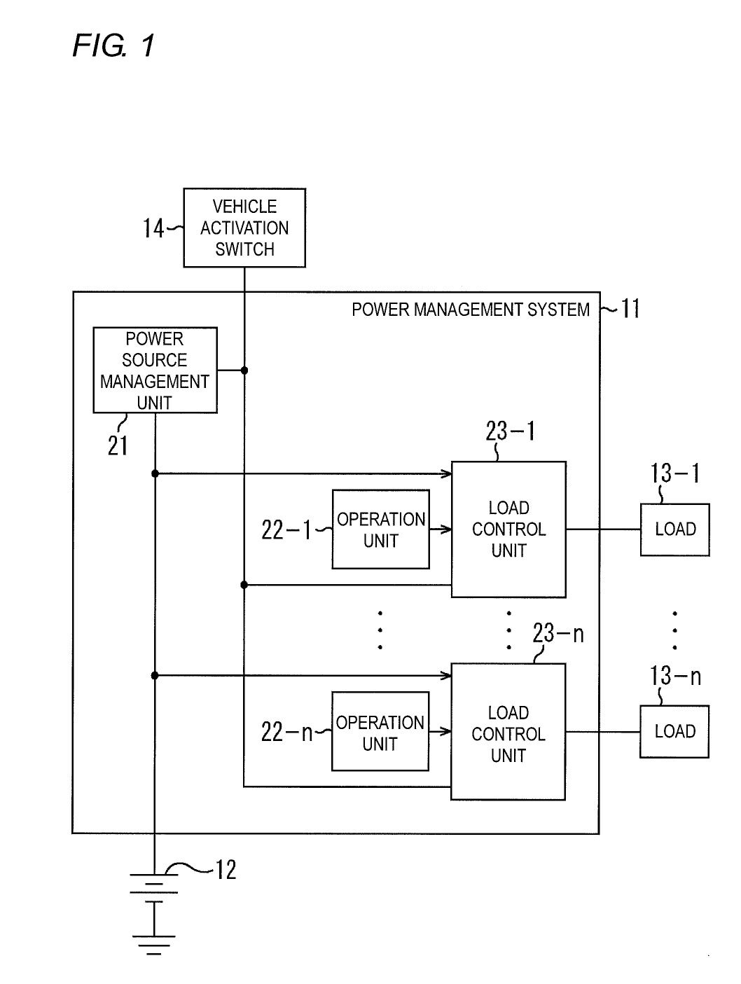

FIG. 1 is a block diagram showing one or more embodiments of a power management system.

A power management system 11 is a system that is provided in each of various types of vehicles to control supply of power to loads 13-1 to 13-n from an in-vehicle battery 12.

The type of the vehicle provided with the power management system 11 is not particularly limited, and includes, for example, an engine vehicle, an EV (Electric Vehicle), an HEV (Hybrid Electric Vehicle), a PHEV (Plug-in Hybrid Electric Vehicle), and the like.

The loads 13-1 to 13-n are made of various in-vehicle electric components, and are classified into traveling system loads, important loads, and normal loads.

The traveling system loads directly involve traveling of the vehicle and are indispensable for traveling of the vehicle. For example, Electric Power Steering (EPS), an electric brake, an Engine Control Unit (ECU), an Electronic Control Unit (ECU) that controls a traveling system and the like are included in the traveling system loads.

The important loads are loads that do not directly involve the traveling of the vehicle, but are loads that interfere with driving or reduce the safety unless they operate. For example, a headlight, a wiper, an SRS (Supplemental Restraint System) air-bag system, ECUs that control these, and the like are included in the important loads.

Accordingly, it can be said that both the traveling system loads and the important loads are loads involving the driving safety of the vehicle.

The normal loads are loads other than the traveling system loads and the important loads. For example, a car audio device, a car navigation device, a motor for power window, a control circuit of an air conditioner, ECUs that control these, and the like are included in the normal loads.

A vehicle activation switch 14 is a switch to switch a state of a power source of the vehicle, start up the vehicle, and is made of, for example, an ignition switch and a power switch.

The vehicle activation switch 14 notifies the power management system 11 of a state (setting position) of its own.

Hereinafter, the vehicle activation switch 14 can be set to four positions of OFF to turn off the power of almost all the in-vehicle instruments, ACC to turn on the power of a part of the in-vehicle instruments, ON to turn on the power of almost all the in-vehicle instruments, and START to start up an engine or a motor. Moreover, it is not until user authentication described later has succeeded that the vehicle activation switch 14 can be set to the states other than OFF.

The power management system 11 includes a power source management unit 21, operation units 22-1 to 22-n, and load control units 23-1 to 23-n. The operation units 22-1 to 22-n and the load control units 23-1 to 23-n are provided, corresponding to the loads 13-1 to 13-n, respectively.

Moreover, the power source management unit 21, the load control units 23-1 to 23-n, and the vehicle activation switch 14 performs communication based on a predetermined communication method (e.g., CAN (Controller Area Network) or the like).

Hereinafter, when the loads 13-1 to 13-n, the operation units 22-1 to 22-n, and the load control units 23-1 to 23-n need not be distinguished individually, each of them is only referred to as a load 13, an operation unit 22, and a load control unit 23.

Moreover, for the load 13 to which the user operation is not performed, the operation unit 22 may not be provided. Furthermore, all operations of the load 13 are not necessarily performed with the operation unit 22, but for example, only a part of operations such as an operation of activation, stop and the like of the load 13 may be performed with the operation unit 22, and the other operations may be performed with an operation unit provided in the load 13.

As will be described later, the power source management unit 21 controls the supply of the power from the battery 12 to each of the loads 13 by controlling each of the load control units 23, based on a result of the user authentication, the state of the vehicle activation switch 14, a load current value notified from each of the load control units 23, and the like.

The operation unit 22 is made up of various operation components such as switches, buttons, a touch panel, and the like. The user operates the operation unit 22 to input an instruction of activation, stop, or the like of the corresponding load 13. The operation unit 22 notifies the load control unit 23 of the inputted instruction.

The load control unit 23 controls the supply of the power to the corresponding load 13, based on the control of the power source management unit 21. Moreover, the load control unit 23 monitors the load current value supplied to the load 13, and notifies the power source management unit 21 of the result. Furthermore, the load control unit 23 controls the operation of the load 13, based on the user instruction notified from the operation unit 22 or the like.

[Configuration Example of Verification System 51]

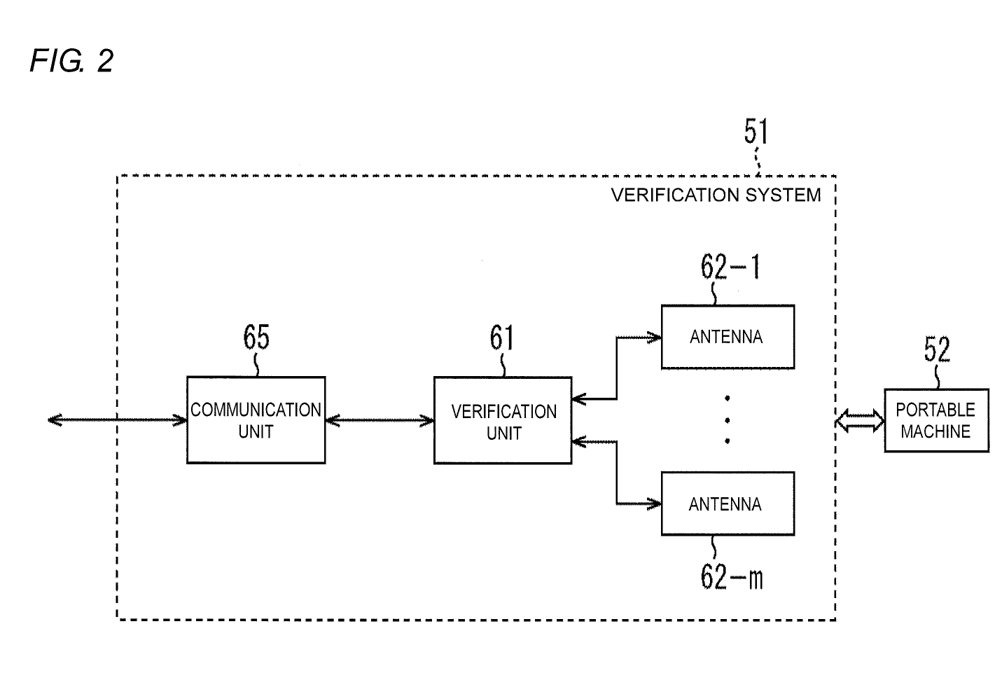

FIG. 2 is a block diagram showing a configuration example of a verification system 51, which is one of the load control units 23.

The verification system 51 is a system to perform the user authentication to permit unlocking of a door lock of the vehicle, the operation of the loads 13 and the vehicle activation switch 14, driving of the vehicle, and the like by communication with a portable machine 52 possessed by the user.

The verification system 51 includes a verification unit 61, antennas 62-1 to 62-m, and a communication unit 65. The antennas 62-1 to 62-m correspond to the loads 13 in FIG. 1.

The verification unit 61 communicates with the portable machine 52 through the antennas 62-1 to 62-m to read an identification number from the portable machine 52 and perform matching between the read identification number and an identification number stored in advance. Moreover, the verification unit 61 performs determination as to whether the portable machine 52 is in a vehicle interior or in a vehicle exterior (hereinafter, referred to as interior/exterior determination), based on the antennas 62-1 to 62-m used for the communication with the portable machine 52. The verification unit 61 then performs the user authentication, based on a matching result and a result of the interior/exterior determination. The verification unit 61 notifies the power source management unit 21 and the like of the result of the user authentication through the communication unit 65.

The antennas 62-1 to 62-m are installed at predetermined positions of the vehicle, respectively to transmit and receive an electromagnetic wave between the portable machine 52 and themselves in predetermined communication areas. The communication areas of a part of the antennas 62-1 to 62-m are set in the vehicle interior, and the remaining communication areas are set in the vehicle exterior.

[Configuration Example of Power Source Management Unit 21]

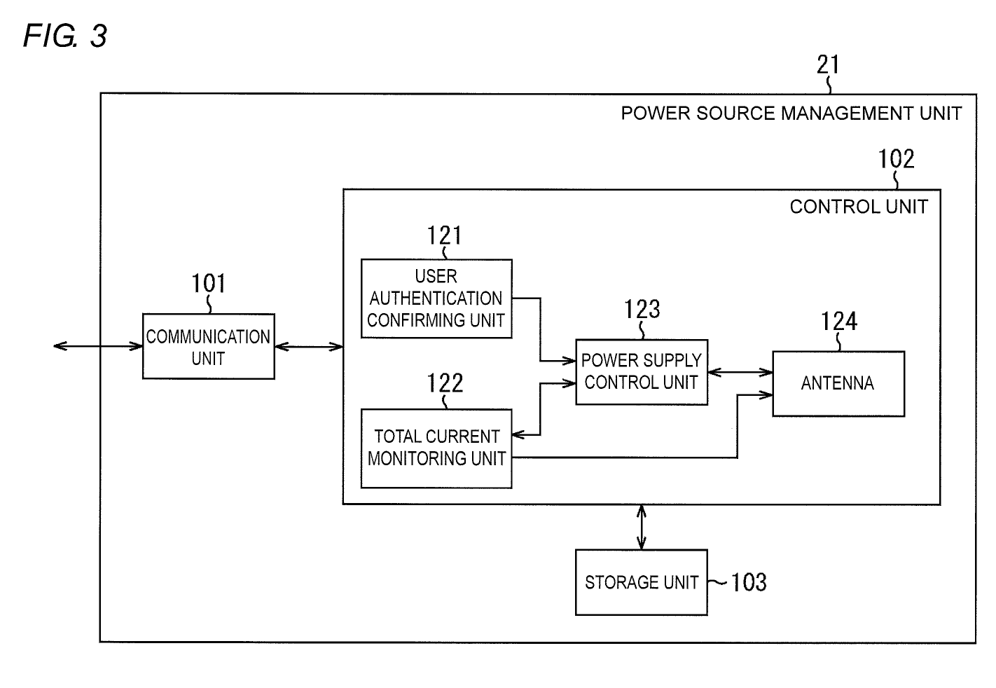

FIG. 3 is a block diagram showing a configuration example of the power source management unit 21.

The power source management unit 21 includes a communication unit 101, a control unit 102, and a storage unit 103.

The communication unit 101 is made of various communication devices or communication circuits. The communication unit 101 performs communication with various devices inside the vehicle such as the load control units 23 and the like, based on a predetermined communication method (e.g., CAN or the like). The communication unit 101 receives a signal transmitted from another device to notify the control unit 102, or to transmit a signal notified from the control unit 102 to another device.

The control unit 102 is made of a processor such as, for example, a CPU (Central Processing Unit), an MPU (Micro Processing Unit), an ECU (Electronic Control Unit), and the like to control processing of the power source management unit 21. The control unit 102 executes a predetermined control program to thereby realize functions including a user authentication confirming unit 121, a total current monitoring unit 122, and a power supply control unit 123.

The user authentication confirming unit 121 communicates with the verification unit 61 through the communication unit 101 to cause the verification unit 61 to execute the user authentication, and receive the result thereof. Moreover, the user authentication confirming unit 121 receives a signal indicating an activation request of the vehicle based on an operation result of the vehicle activation switch 14 through the communication unit 101. Based on the result of the user authentication by the verification unit 61, and the operation result of the vehicle activation switch 14, the user authentication confirming unit 121 stores a vehicle activation state in the storage unit 103. Furthermore, the user authentication confirming unit 121 notifies the power supply control unit 123 of the result of the user authentication or the activation state of the vehicle.

The total current monitoring unit 122 communicates with the respective load control units 23 through the communication unit 101 to detect a total current value, which is a sum of the load current values, based on the load current values notified from the respective load control units 23. The total current monitoring unit 122 performs abnormality determination of the total current value in accordance with a request from the power supply control unit 123, and notifies the power supply control unit 123 of a determination result.

The power supply control unit 123 communicates with the respective load control units 23 through the communication unit 101. In accordance with the request from each of the load control units 23, the power supply control unit 123 determines whether or not the supply of the power from the load control unit 23 as a request source to the load 13 is permitted, based on the result of the user authentication and the result of abnormality determination of the total current value. Moreover, the power supply control unit 123 notifies the load control unit 23 as the request source of a determination result of whether or not the power supply is permitted through the communication unit 101, by which the supply of the power from the load control unit 23 to the load 13 is controlled.

The storage unit 103 is made of a storage device such as, for example, an EEPROM (Electrically Erasable Programmable Read-Only Memory) and the like. The storage unit 103 stores programs and data necessary for the processing of the control unit 102.

[Configuration Example of Load Control Unit 23]

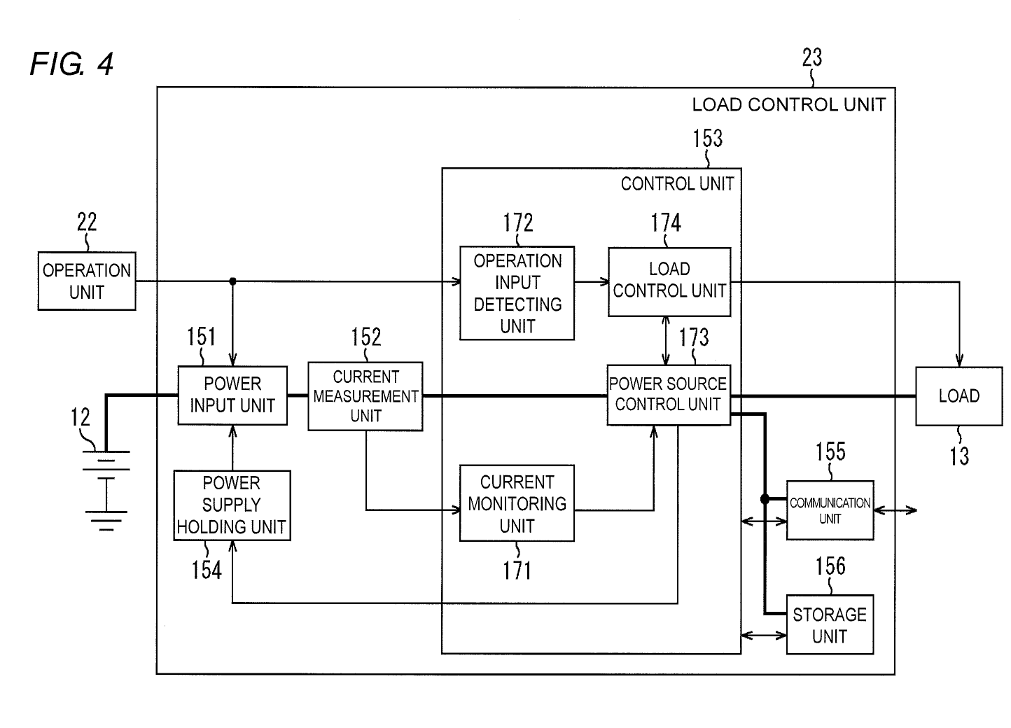

FIG. 4 is a block diagram showing a configuration example of the load control unit 23.

The load control unit 23 includes a power input unit 151, a current measurement unit 152, a control unit 153, a power supply holding unit 154, a communication unit 155, and a storage unit 156.

The power input unit 151 is activated when a predetermined signal (e.g., signal instructing the activation of the load 13) is inputted from the operation unit 22, and supplies the power supplied from the battery 12 to the control unit 153. The power input unit 151 continues the supply of the power to the control unit 153 by an activation signal notified from the power supply holding unit 154 even after stop of the input of the predetermined signal from the operation unit 22, and when the supply of the activation signal stops, the power input unit 151 stops the supply of the power to the control unit 153.

The current measurement unit 152 is made of, for example, a current sensor, a current transformer, and the like. The current measurement unit 152 measures the load current value flowing from the power input unit 151 to the control unit 153 and notifies the control unit 153 of a signal indicating a measurement result. The load current value measured by the current measurement unit 152 includes a current consumed by the load control unit 23 in addition to a current supplied to the load 13.

The control unit 153 is made of a processor such as, for example, a CPU, an MPU, an ECU, and the like, various electric circuits and the like to control the supply of the power into the load 13 and the load control unit 23, and control the load 13.

The control unit 153 includes a current monitoring unit 171, an operation input detection unit 172, a power source control unit 173, and a load control unit 174.

The current monitoring unit 171 detects the load current value, based on the signal notified from the current measurement unit 152. Moreover, the current monitoring unit 171 performs the abnormality determination of the load current value to notify the power source control unit 173 of a determination result.

The operation input detection unit 172 detects the instruction to the load 13 inputted by the user operating the operation unit 22 to notify the load control unit 174 of the detected user instruction.

The power source control unit 173 communicates with the power source management unit 21 through the communication unit 155 to notify the power source management unit 21 of the abnormality of the load current value and the state of the load 13, and confirm whether or not the power supply to the load 13 is permitted. The power source control unit 173 controls the supply of the power to the load 13, based on the determination result of whether or not the power supply to the load 13 is permitted by the power source management unit 21, the user instruction inputted from the operation unit 22 through the operation input detection unit 172 and the like. Moreover, the power source control unit 173 notifies the load control unit 174 of the determination result of whether or not the power supply to the load 13 is permitted by the power source management unit 21.

Furthermore, when abnormality occurs in the load 13, the power source control unit 173 notifies the load control unit 23 controlling a warning display unit as one of the loads 13 of the abnormality occurrence of the load 13 through the communication unit 155.

Moreover, the power source control unit 173 controls the power supply holding unit 154 to thereby control the supply of the power from the battery 12 to the control unit 153 by the power input unit 151.

The load control unit 174 controls the operation of the load 13, based on the user instruction inputted from the operation unit 22 through the operation input detection unit 172, an instruction inputted from the outside through the communication unit 155, or the like. Moreover, the load control unit 174 notifies the power source control unit 173 of the inputted user instruction as needed.

The power supply holding unit 154 is made of, for example, various electric circuits, and notifies the power input unit 151 of the activation signal, based on the control of the power source control unit 173.

The communication unit 155 is made of various communication devices or communication circuits. The communication unit 155 performs communication with various devices inside the vehicle such as the power source management unit 21 and the like, based on a predetermined communication method (e.g., CAN or the like). The communication unit 155 receives a signal transmitted from another device to notify the control unit 153 of the same, or transmits a signal notified from the control unit 153 to another device.

The storage unit 156 is made of a storage device such as, for example, an EEPROM. The storage unit 156 stores programs and data necessary for the processing of the control unit 153.

[Processing of Power Management System 11]

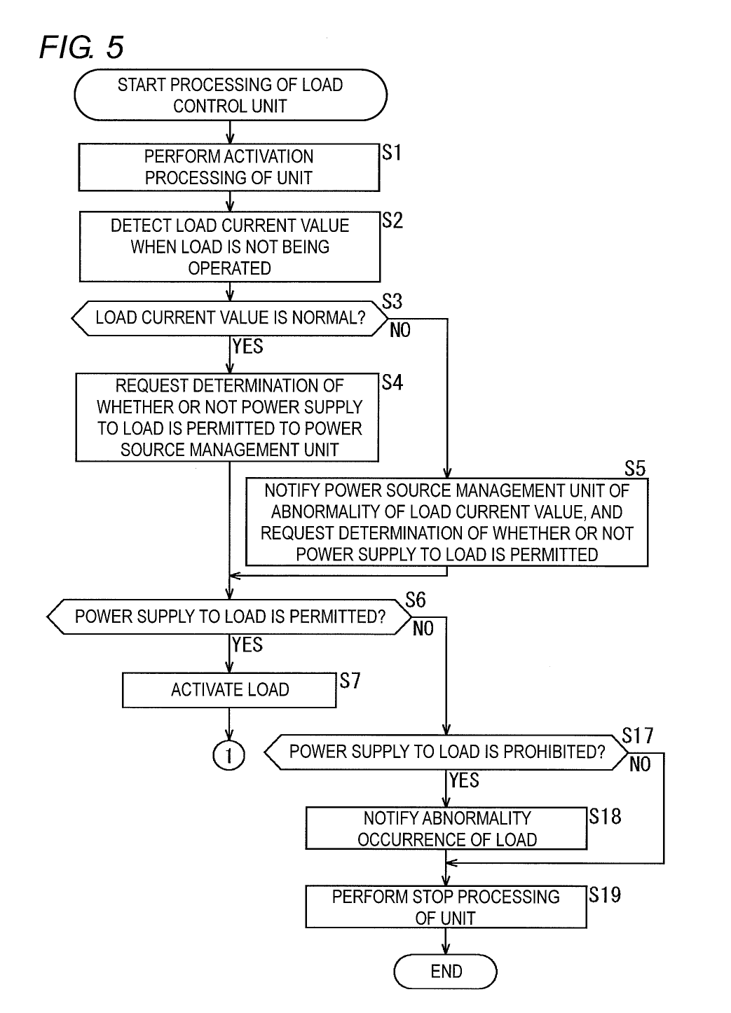

Next, referring to FIGS. 5 to 9, one example of processing executed by the power management system 11 will be described.

[Processing of Load Control Unit 23]

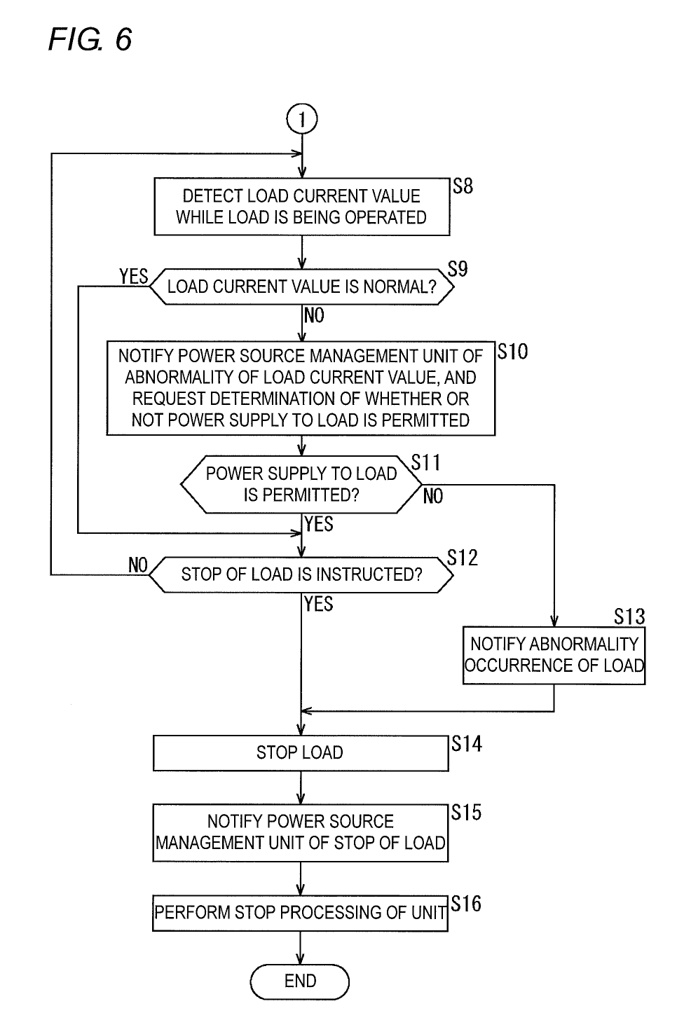

Referring to flowcharts in FIG. 5 and FIG. 6, one example of processing of the load control unit 23 will be described.

This processing is executed by the load control unit 23 to which a signal instructing the activation of the load 13 (hereinafter, referred to as a load activation signal) is inputted, when the load activation signal is inputted from the operation unit 22.

In step S1, the load control unit 23 performs activation processing of the unit. Specifically, the power input unit 151 is activated in accordance with the load activation signal notified from the operation unit 22. The power input unit 151 supplies the power from the battery 12 to the power source control unit 173 of the control unit 153. This activates the respective units of the control unit 153 to start the processing.

Moreover, the power source control unit 173 activates the power supply holding unit 154. The power supply holding unit 154 then starts the supply of the activation signal to the power input unit 151. This allows the power input unit 151 to continue the power supply to the power source control unit 173 without stopping even if the input of the load activation signal from the operation unit 22 is stopped.

Furthermore, the power source control unit 173 starts the supply of the power to the communication unit 155 and the storage unit 156. This activates the communication unit 155 and the storage unit 156.

In step S2, the current monitoring unit 171 detects the load current value when the load 13 is not being operated, based on the signal notified from the current measurement unit 152.

In step S3, the current monitoring unit 171 determines whether or not the load current value is normal. Specifically, the current monitoring unit 171 compares the detected load current value with a predetermined threshold stored in the storage unit 156 (hereinafter, referred to as a load current threshold). If the load current value is equal to or lower than the load current threshold, the current monitoring unit 171 determines that the load current value is normal, and notifies the power source control unit 173 that the load current value is normal.

Thereafter, the processing goes to step S4.

The load current threshold can be individually set for each of the load control units 23 in view of a consumption current of each of the loads 13 and the like.

In step S4, the power source control unit 173 transmits a signal requesting the determination of whether or not the supply of the power to the load 13 is permitted (hereinafter, referred to as a power-supply determination request signal) through the communication unit 155, thereby requesting the determination of whether or not the power supply to the load 13 is permitted to the power source management unit 21.

Thereafter, the processing goes to step S6.

On the other hand, in step S3, when the load current value exceeds the load current threshold, the current monitoring unit 171 determines that the load current value is abnormal, and notifies the power source control unit 173 of the load current value in which abnormality occurs (hereinafter, referred to as an abnormal current value).

Thereafter, the processing goes to step S5.

In step S5, the power source control unit 173 adds information indicating the abnormal current value to the power-supply determination request signal and transmits the signal through the communication unit 155 to thereby notify the power source management unit 21 of the abnormality of the load current value and request the determination of whether or not the power supply to the load 13 is permitted.

Thereafter, the processing goes to step S6.

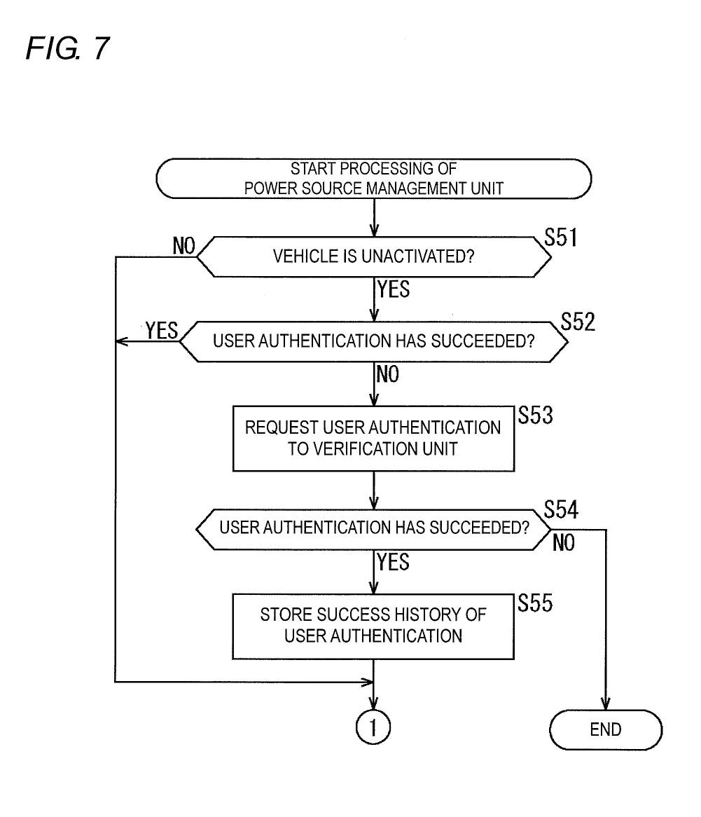

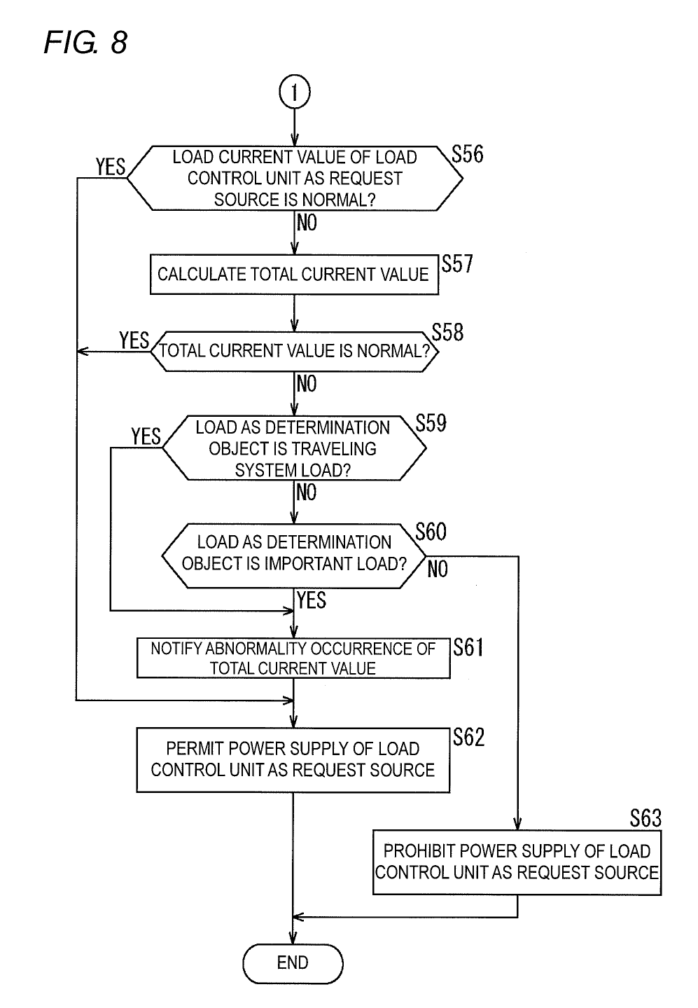

The power source management unit 21 determines whether or not the power supply to the load 13 is permitted with respect to the request from the load control unit 23 in processing in FIG. 7 and FIG. 8 described later. The power source management unit 21 transmits a power supply permitting signal to notify the permission of the power supply to the load 13 or a power supply prohibiting signal to notify the prohibition of the power supply to the load 13 to the load control unit 23 as the request source. However, if the user authentication described later does not succeed, the power source management unit 21 does not perform the determination of whether or not the power supply is permitted, and does not transmit either of the power supply permitting signal and the power supply prohibiting signal.

In step S6, the power source control unit 173 determines whether or not the power supply to the load 13 is permitted. If receiving the power supply permitting signal through the communication unit 155 from the power source management unit 21 within a predetermined time from the transmission of the power-supply determination request signal, the power source control unit 173 determines that the power supply to the load 13 is permitted, and notifies the load control unit 174 that the power supply to the load 13 is permitted.

Thereafter, the processing goes to step S7.

In step S7, the load control unit 23 activates the load 13. Specifically, the power source control unit 173 supplies the power from the battery 12 to the load 13. This activates the load 13 to start the operation. Moreover, the power source control unit 173 notifies the load control unit 174 that the power supply to the load 13 has started. The load control unit 174 starts the processing for controlling the operation of the load 13.

In step S8, the current monitoring unit 171 detects the load current value while the load 13 is operating, based on the signal notified from the current measurement unit 152.

In step S9, similarly to the processing in step S3, whether or not the load current value is normal is determined. If it is determined that the load current value is abnormal, the processing goes to step S10.

In step S10, similarly to the processing in step S5, the abnormality of the load current value is notified to the power source management unit 21, and the determination of whether or not the power supply to the load 13 is permitted is requested to the power source management unit 21.

In step S11, similarly to the processing in step S6, whether or not the power supply to the load 13 is permitted is determined. If it is determined that the power supply to the load 13 is permitted, the processing goes to step S12.

On the other hand, if it is determined in step S9 that the load current value is normal, the processing in steps S10 and S11 is skipped to go to step S12. That is, if the load current value is normal, determination of whether or not the power supply to the load 13 is permitted is not requested to the power source management unit 21.

In step S12, the load control unit 174 determines whether or not the stop of the load 13 has been instructed. If the instruction of the stop of the load 13 has not been inputted from the operation unit 22 through the operation input detection unit 172, the load control unit 174 determines that the stop of the load 13 has not been instructed, and the processing returns to step S8.

Thereafter, until it is determined in step S11 that the power supply to the load 13 is prohibited or until it is determined in step S12 that the stop of the load 13 is instructed, the processing from steps S8 to S12 are executed repeatedly. That is, the processing is continuously performed in which the power source management unit 21 is notified of the abnormal current value when the abnormality of the load current value occurs, and whether or not the power supply to the load 13 is permitted is confirmed with the power source management unit 21, while supplying the power to the load 13.

On the other hand, in step S12, if the instruction of the stop of the load 13 is inputted from the operation unit 22 through the operation input detection unit 172, the load control unit 174 determines that the stop of the load 13 has been instructed, and notifies the power source control unit 173 that the stop of the load 13 has been instructed.

Thereafter, the processing goes to step S14.

Moreover, in step S11, if receiving the power supply prohibiting signal from the power source management unit 21 through the communication unit 155, the power source control unit 173 determines that the power supply to the load 13 is prohibited, and notifies the load control unit 174 that the power supply to the load 13 is prohibited.

Thereafter, the processing goes to step S13.

In step S13, the power source control unit 173 notifies the abnormality occurrence of the load. For example, the power source control unit 173 notifies, through the communication unit 155, the load control unit 23 controlling the warning display unit as one of the loads 13 that the load 13 will stop due to the abnormality of the load current value.

At this time, for example, the power source control unit 173 may perform the notification to the load control unit 23 controlling the warning display unit through the power source management unit 21.

The warning display unit performs warning to communicate the occurrence of the abnormality of the load current value of the load 13, the abnormal stop of the load 13 and the like to the user by a predetermined method using, for example, an image, a text, a light, a sound, or the like.

Thereafter, the processing goes to step S14.

In step S14, the load control unit 23 stops the load 13. Specifically, the load control unit 174 stops the control of the load. Moreover, the power source control unit 173 stops the supply of the power to the load 13. This allows the load 13 to stop the operation.

In step S15, the power source control unit 173 transmits a load stop signal to notify the stop of the load 13 through the communication unit 155 to thereby notify the power source management unit 21 of the stop of the load 13.

In step S16, the load control unit 23 performs stop processing of the unit. Specifically, the power source control unit 173 stops the supply of the power to the communication unit 155 and the storage unit 156. Moreover, the power source control unit 173 causes the supply of the activation signal from the power supply holding unit 154 to the power input unit 151 to be stopped. This stops the power input unit 151, and as a result, the supply of the power from the battery 12 to the control unit 153 stops, so that the control unit 153 stops the operation.

Thereafter, the processing of the load control unit 23 ends.

On the other hand, in step S6, if the power source control unit 173 receives the power supply prohibiting signal within the predetermined time from the transmission of the power-supply determination request signal, or if neither of the power supply permitting signal and the power supply prohibiting signal is received within the same, the power source control unit 173 determines that the power supply to the load 13 is not permitted, and the processing goes to step S17.

In step S17, the power source control unit 173 determines whether or not the power supply to the load 13 is prohibited. If the power source control unit 173 receives the power supply prohibiting signal through the communication unit 155 from the power source management unit 21 within the predetermined time from the transmission of the power-supply determination request signal, the power source control unit 173 determines that the power supply to the load 13 is prohibited, and notifies the load control unit 174 that the power supply to the load 13 is prohibited.

Thereafter, the processing goes to step S18.

In step S18, similarly to the processing in step S13, the abnormality occurrence of the load 13 is notified.

Thereafter, the processing goes to step S19.

On the other hand, in step S17, if the power source control unit 173 receives neither the power supply permitting signal nor the power supply prohibiting signal within the predetermined time from the transmission of the power-supply determination request signal, the power source control unit 173 determines that the power supply to the load 13 is neither permitted nor prohibited, and the processing in step S18 is skipped to go to step S19.

As will be described later, this is a case where the user authentication does not succeed within the predetermined time, and the determination of whether or not the power supply is permitted is not performed in the power source management unit 21.

In step S19, similarly to the processing in step S16, the stop processing of the unit is performed, and then, the processing of the load control unit 23 ends.

[Processing of Power Source Management Unit 21]

Next, referring to flowcharts in FIG. 7 and FIG. 8, the processing of the power source management unit 21 executed corresponding to the processing of the load control unit 23 in FIG. 5 and FIG. 6 will be described.

This processing is started when the control unit 102 of the power management unit 21 receives the power-supply determination request signal transmitted from the load control unit 23 through the communication unit 101.

In step S51, the user authentication confirming unit 121 determines the activation state of the vehicle, based on an activation operation result signal of the vehicle notified from the vehicle activation switch 14 through the communication unit 101. If it is determined that the vehicle is not activated, based on the operation result of the vehicle activation switch 14, the processing goes to step S52.

In step S52, the user authentication confirming unit 121 determines whether or not the user authentication has succeeded. If a success history of the user authentication is not stored in the storage unit 103, the user authentication confirming unit 121 determines that the user authentication has not succeeded yet, and the processing goes to step S53.

In step S53, the user authentication confirming unit 121 requests the user authentication to the verification unit 61 by transmitting a user authentication request signal that requests the user authentication through the communication unit 101.

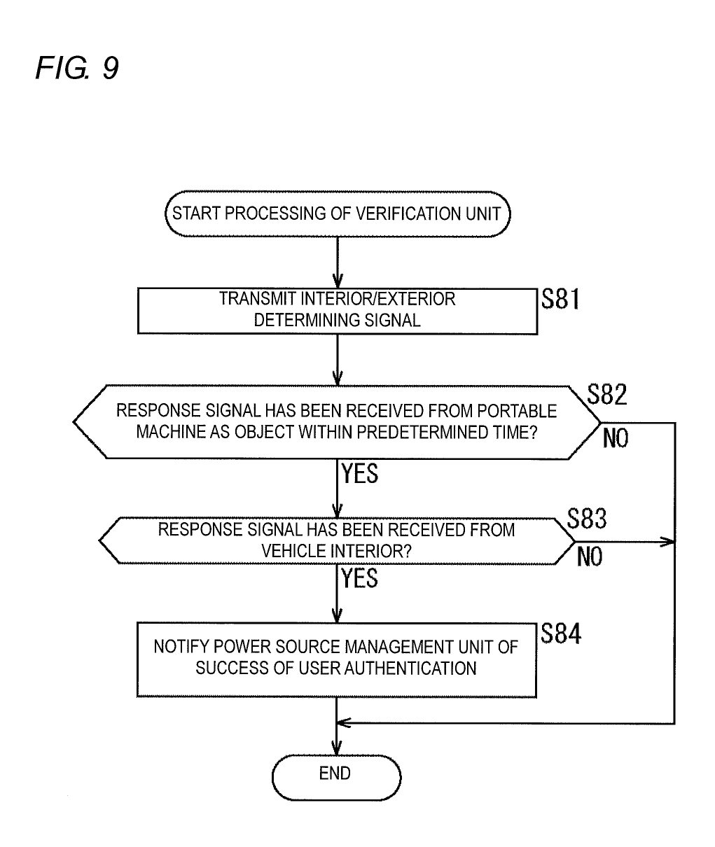

The verification unit 61 executes the user authentication by the processing in FIG. 9 described later, and if the authentication has succeeded, the verification unit 61 transmits, to the power source management unit 21, a user authentication success signal notifying the success of the user authentication.

In step S54, the user authentication confirming unit 121 determines whether or not the user authentication has succeeded. If the user authentication confirming unit 121 receives the user authentication success signal from the verification unit 61 through the communication unit 101 within a predetermined time from the transmission of the user authentication request signal, the user authentication confirming unit 121 determines that the user authentication has succeeded, and the processing goes to step S55.

In step S55, the user authentication confirming unit 121 stores the success history of the user authentication in storage unit 103. Moreover, the user authentication confirming unit 121 notifies the power supply control unit 123 that the user authentication has succeeded.

Thereafter, the processing goes to step S56.

The success history of the user authentication is deleted from the storage unit 103, for example, when all the loads 13 stop, or when the user authentication periodically performed by the verification unit 61 fails and the failure of the user authentication is notified from the verification unit 61.

On the other hand, in step S52, if the success history of the user authentication is stored in the storage unit 103, the user authentication confirming unit 121 determines that the user authentication has succeeded, and notifies the power supply control unit 123 that the user authentication has succeeded.

Thereafter, the processing in steps S53 to S55 is skipped to go to step S56.

On the other hand, in step S51, if it is determined that the vehicle is activated, the user authentication confirming unit 121 notifies the power supply control unit 123 that the user authentication has succeeded. That is, as described above, since the vehicle is not activated unless the user authentication has succeeded, the user authentication is considered to have succeeded if the vehicle is in an activated state.

Thereafter, the processing in steps S52 to S55 is skipped to go to step S56.

In step S56, the power supply control unit 123 determines whether or not the load current value of the load control unit 23 as the request source is normal. If the information indicating the abnormal current value is added to the power-supply determination request signal, the power supply control unit 123 determines that the load current value of the load control unit 23 as the request source is abnormal, and the processing goes to step S57.

In step S57, the total current monitoring unit 122 calculates the total current value. Specifically, the power supply control unit 123 instructs the abnormality determination of the total current value to the total current monitoring unit 122. The total current monitoring unit 122 sums the load current values of the load control unit 23 as the request source, and the load control units 23 supplying the power to the loads 13 among the other load control units 23 to thereby calculate the total current value.

At this time, the total current monitoring unit 122 uses the notified abnormal current value for the load control unit 23 in which the abnormal current value is notified. On the other hand, for the load control unit 23 in which the abnormal current value is not notified, the total current monitoring unit 122 uses the load current value decided for each of the load control units 23 in advance and stored in the storage unit 103 (hereinafter, referred to as a standard current value). The standard current value is set, based on a specification of each of the loads 13 and the like.

In this manner, calculating the total current value using the standard current values makes it unnecessary to notify the power source management unit 21 of the load current values from the respective load control units 23 at the time of other than the abnormality occurrence, thereby reducing burden on the communication.

In step S58, the total current monitoring unit 122 determines whether or not the total current value is normal. The total current monitoring unit 122 compares the calculated total current value with a predetermined threshold stored in the storage 103 (hereinafter, referred to as a total current threshold). If the total current value exceeds the total current threshold, the total current monitoring unit 122 determines that the total current value is abnormal, and notifies the power supply control unit 123 that the total current value is abnormal.

Thereafter, the processing goes to step S59.

The total current threshold is set, for example, based on an allowable current value and the like of the battery 12.

In step S59, the power supply control unit 123 determines whether or not the load 13 is a determination object, that is, the load 13 of the load control unit 23 as the request source is the traveling system load. If it is determined that the load 13 as the determination object is not the traveling system load, the processing goes to step S60.

In step S60, the power supply control unit 123 determines whether or not the load 13 as the determination object is the important load. If it is determined that the load 13 as the determination object is the important load, the processing goes to step S61.

On the other hand, in step S59, if it is determined that the load 13 as the determination object is the traveling system load, the processing in step S60 is skipped to go to step S61.

In step S61, the power supply control unit 123 notifies the abnormality occurrence of the total current value.

Specifically, the power supply control unit 123 notifies, through the communication unit 101, the load control unit 23 controlling the warning display unit, which is one of the loads 13, that the abnormality of the total current value occurs due to the abnormality of the load current values of a part of the loads 13.

The warning display unit performs warning to inform the user of the occurrence of the abnormality in the total current value by the predetermined method using, for example, an image, a text, a light, a sound, or the like.

Thereafter, the processing goes to step S62.

On the other hand, in step S58, if the total current value is equal to or lower than the total current threshold, the total current monitoring unit 122 determines that the total current value is normal, and notifies the power supply control unit 123 that the total current value is normal.

Thereafter, the processing in steps S59 to S61 is skipped to go to step S62.

Moreover, if it is determined in step S56 that the load current value of the load control unit 23 as the request source is normal, the processing in steps S57 and S61 is skipped to go to step S62.

In step S62, the power supply control unit 123 transmits the power supply permitting signal through the communication unit 101 to thereby permit the power supply of the load control unit 23 as the request source.

That is, if any of the following conditions (1) to (3) is satisfied, the power supply to the load 13 as the determination object is permitted.

(1) The load current value of the load control unit 23 of the request source is normal.

(2) The total current value is normal.

(3) The load 13 as the determination object is the traveling system load or the important load.

Accordingly, if the total current value is normal, the power supply to the load 13 of the determination object is started or continued even if the load current value of the load control unit 23 as the request source is abnormal.

Moreover, if the load 13 as the determination object is the traveling system load or the important load, the power supply to the load 13 as the determination object is started or continued regardless of the presence or absence of the occurrence of the abnormality in the load current value and the total current value.

Thereafter, the processing of the power source management unit 21 ends.

On the other hand, in step S60, if it is determined that the load 13 as the determination object is not the important load, that is, if the load 13 as the determination object is the normal load, the processing goes to step S63.

In step S63, the power supply control unit 123 transmits the power supply prohibiting signal through the communication unit 101 to thereby prohibit the power supply of the load control unit 23 as the request source. That is, if the load current value of the load control unit 23 as the request source is abnormal and if the total current value is abnormal, and if the load 13 as the determination object is the normal load, the power supply to the relevant load 13 is prohibited.

Thereafter, the processing of the power source management unit 21 ends.

On the other hand, in step S54, if the user authentication confirming unit 121 does not receive the user authentication success signal from the verification unit 61 within the predetermined time from the transmission of the user authentication request signal, the user authentication confirming unit 121 determines that the user authentication has failed, and notifies the power supply control unit 123 that the user authentication has failed.

Thereafter, the processing of the power source management unit 21 ends.

That is, in this case, the determination of whether or not the power supply is permitted is not performed, and neither the power supply permitting signal nor the power supply prohibiting signal is transmitted from the power source management unit 21.

[Processing of Verification Unit 61]

Next, referring to the flowchart in FIG. 9, processing executed by the verification unit 61 will be described, corresponding to the processing of the power source management unit 21 in FIGS. 7 and 8.

This processing is started when the verification unit 61 receives, through the communication unit 65, the user authentication request signal transmitted by the power source management unit 21.

In step S81, the verification unit 61 transmits an interior/exterior determining signal from each of the antennas 62.

In step S82, the verification unit 61 determines whether or not a response signal has been received from the portable machine 52 as an object within a predetermined time.

Specifically, if the portable machine 52 exists inside a communication area of any of the antennas 62, and has received the interior/exterior determining signal transmitted from the relevant antennas 62, the portable machine 52 transmits the response signal including an identification number of its own.

If the verification unit 61 receives the response signal from the portable machine 52 through the antenna 62 within the predetermined time from the start of the transmission of the interior/exterior determining signal, the verification unit 61 compares the identification number included in the received response signal with the identification number stored in advance. If the identification numbers are matched, the verification unit 61 determines that the response signal has been received from the portable machine 52 as the object, and the processing goes to step S83.

In step S83, the verification unit 61 determines whether or not the response signal has been received from the vehicle interior. If the response signal has been received from the portable machine 52 through the antenna 62 whose communication area is set in the vehicle interior, the verification unit 61 determines that it has received the response signal from the vehicle interior, and the processing goes to step S84.

In step S84, the verification unit 61 transmits the user authentication success signal notifying the success of the user authentication through the communication unit 65 to thereby notify the power source management unit 21 of the success of the user authentication.

That is, if the portable machine 52 having the identification number matching the identification number registered in advance exists inside the communication area in the vehicle interior of each of the antennas 62, the user authentication has succeeded, and the power source management unit 21 is notified of the success of the user authentication.

Thereafter, the processing of the verification unit 61 ends.

On the other hand, in step S83, if the response signal has been received from the portable machine 52 through the antenna 62 whose communication area is set in the vehicle exterior, the verification unit 61 determines that it has received the response signal from the vehicle exterior, and the processing in step S84 is skipped to end the processing of the verification unit 61.

Moreover, in step S82, if the verification unit 61 cannot receive the response signal from the portable machine 52 within the predetermined time from the start of the transmission of the interior/exterior determining signal, or if the identification number included in the response signal received from the portable machine 52 does not match the identification number stored in advance, the verification unit 61 determines that it has not received the response signal from the portable machine 52 as the object within the predetermined time, the processing in steps S83 and S84 is skipped to end the processing of the verification unit 61.

That is, if the portable machine 52 having the identification number matching the identification number registered in advance does not exist in the communication area in the vehicle interior of each of the antennas 62, the user authentication will fail. In this case, the power source management unit 21 is not notified of the failure of the user authentication.

As described above, even if the abnormality of the load current value is detected, the operation of the load 13 in which the abnormality of the load current value occurs is started or continued as long as the total current value is normal. Accordingly, for example, in the case where the load current value temporarily becomes abnormal due to the variation of the load 13, or the like, the load 13 can be prevented from being unnecessarily stopped.

Moreover, when the load 13 is the traveling system load or the important load, the load 13 is not stopped even if the abnormality of the load current value is detected, and thus, safe traveling of the vehicle can be sustained.

Hereafter, modifications of the one or more embodiments of the present invention will be described.

### First Modification

For example, the power source management unit 21 may be periodically notified of the load current value from the each of the load control units 23 during operation regardless of the presence or absence of the occurrence of the abnormality in the load current value. In the power source management unit 21, the total current value may be detected, based on the load current values actually detected in the respective load control units 23 to perform the abnormality determination of the total current value.

### Second Modification

Moreover, for example, when the vehicle is in a predetermined state where it is at least not traveling, the traveling system loads and the important loads may be enabled to be stopped at the time of abnormality in the load current value and the total current value, as with the normal loads. It is desirable that this predetermined state does not include a state having a possibility that the vehicle is ready to travel, such as during temporary stop and the like.

### Third Modification

Furthermore, the traveling system loads and the important loads may be changed in real time in accordance with the state of the vehicle, the surrounding environments, and the like. Moreover, the load current thresholds and the total current threshold may be varied in real time in accordance with the state of the vehicle, the surrounding environments and the like.

### Fourth Modification

Furthermore, the classification of the loads is not limited to the above-described example, and for example, the number of classes can be changed or classification using different references can be employed.

### Fifth Modification

Moreover, if the user authentication has not succeeded, the failure of the user authentication may be notified from the verification unit 61 to the power source management unit 21. Furthermore, if the user authentication has failed, the power supply prohibiting signal may be transmitted to the load control unit 23 as the request source from the power source management unit 21.

### Sixth Modification

Furthermore, the power source that supplies the power to the respective loads 13 is not limited to the battery, and the present invention can also be applied to a case where a power source other than the battery is used.

The above-described series of processing can be executed by hardware, or by software. If the above-described series of processing is executed by the software, a program configuring the software is installed on a computer. Here, the computer includes a computer incorporated in dedicated hardware, such as the control unit 102 of the power source management unit 21, the control unit 153 of the load control unit 23, and the like, and for example, a general-purpose personal computer that can execute various functions by installing various programs, and the like.

The program executed by the computer may be a program that performs the series of processing chronologically along the order described in the present specification, or may be a program that performs the series of processing in parallel, or at necessary timing such as when calling is performed and the like.

Moreover, in the present specification, a term “system” means an overall device made up of a plurality of devices, means, and the like.

Furthermore, the embodiments of the present invention is not limited to the above-described embodiment, but various modifications can be made. While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A power source control device provided in a vehicle including a plurality of power supply devices that supply power from a power source to respective corresponding loads, the power source control device comprising:
a total current detecting unit that detects a total current value, which is a summation of load current values, based on the load current values that are supplied from the power supply devices to the loads and are detected in the respective power supply devices; and
a power supply control unit that causes the supply of the power from the relevant power supply device to the load to be stopped when the total current value exceeds a predetermined total current threshold, and causes the supply of the power from the relevant power supply device to the load to be continued when the total current value is equal to or lower than the total current threshold, in a case where the power supply device in which the load current value exceeds a predetermined load current threshold is present.

2. The power source control device according to claim 1, wherein
the power supply control unit causes the supply of the power from the relevant power supply device to the load to be continued, when the load of the power supply device in which the load current value exceeds the load current threshold is a load involving predetermined driving safety of the vehicle.

3. The power source control device according to claim 2, wherein
in a case where the vehicle is in a predetermined state where the vehicle is at least not traveling, the power supply control unit causes the supply of the power from the relevant power supply device to the load to be stopped even when the load of the power supply device in which the load current value exceeds the load current threshold is the load involving the driving safety of the vehicle.

4. The power source control device according to claim 1, wherein
when abnormality of the load current value is notified from the power supply device, the power supply control unit causes determination of whether or not the total current value exceeds the total current threshold to be performed, and when the total current value exceeds the total current threshold, the power supply control unit causes the supply of the power from the relevant power supply device to the load to be stopped, while when the total current value is equal to or lower than the total current threshold, the power supply control unit causes the supply of the power from the relevant power supply device to the load to be continued.

5. The power source control device according to claim 1, wherein
the load current threshold is set individually for each of the loads.

6. A power source control method in a vehicle including a plurality of power supply devices that supply power from a power source to respective corresponding loads, comprising the steps of:
detecting a total current value, which is a summation of load current values, based on the load current values that are supplied from the power supply devices to the loads and are detected in the respective power supply devices; and
causing the supply of the power from the relevant power supply device to the load to be stopped when the total current value exceeds a predetermined total current threshold, and causing the supply of the power from the relevant power supply device to the load to be continued when the total current value is equal to or lower than the total current threshold, in a case where the power supply device in which the load current value exceeds a predetermined load current threshold is present.

7. A power management system for a vehicle, comprising a plurality of power supply devices and a power source control device, wherein
each of the plurality of power supply devices includes:
a power supply unit that supplies power from a power source to a corresponding load; and
a load current detecting unit that detects a load current value supplied to the load, and
the power source control device includes:
a total current detecting unit that detects a total current value, which is a summation of the load current values, based on the load current values that are detected in the power supply devices; and
a power supply control unit that causes the supply of the power from the relevant power supply device to the load to be stopped when the total current value exceeds a predetermined total current threshold, and causes the supply of the power from the relevant power supply device to the load to be continued when the total current value is equal to or lower than the total current threshold, in a case where the power supply device in which the load current value exceeds a predetermined load current threshold is present.
